(19) United States
(12) Patent Application Publication
(10) Pub. No.: US 2015/0268478 A1
(43) Pub. Date: Sep. 24, 2015

(54) DISPLAY DEVICE

(71) Applicant: Samsung Display Co., Ltd., Yongin-City (KR)

(72) Inventor: YOUNGCHAN KIM, Incheon (KR)

(21) Appl. No.: 14/624,811

(22) Filed: Feb. 18, 2015

(30) Foreign Application Priority Data
Mar. 18, 2014 (KR) 10-2014-0031714

(51) Int. Cl. G02B 27/22; H04N 13/04; G02F 1/1343; G02F 1/1347; G02F 1/1334; G02F 1/1335

(52) U.S. Cl. CPC G02B 27/2214; G02F 1/1334; G02F 1/133526; G02F 1/134336; G02F 1/1347; G02F 1/133528; H04N 13/0402; H04N 13/0409; H04N 13/0404; H04N 13/0434; H04N 13/0452; H04N 13/0497; G02F 2001/13478

(57) ABSTRACT

A display device includes a transmissive display module and an optical control member which provides light emitted from a light source to the transmissive display module. The optical control member includes a barrier member and a focus control member coupled to a surface of the barrier member. The barrier member includes a polymer-dispersed liquid crystal layer to transmit or reflect the light incident thereto based on an arrangement of liquid crystal droplets therein. A left-eye barrier pattern and a right-eye barrier pattern are formed at different time points by controlling the arrangement of the liquid crystal droplets.

This application claims priority to Korean Patent Application No. 10-2014-0031714, filed on Mar. 18, 2014, and all the benefits accruing therefrom under 35 U.S.C. §119, the content of which in its entirety is herein incorporated by reference.

### BACKGROUND

1. Field

The disclosure relates to a display device. More particularly, the disclosure relates to a display device with improved light efficiency.

2. Description of the Related Art

A display device may display a two-dimensional (“2D”) image or a three-dimensional (“3D”) image based on an operation mode thereof. In general, a resolution of the 3D image is lower than that of the 2D image.

The display device may display the 3D image using a stereoscopic technique or an autostereoscopic technique. The stereoscopic display device provides the 3D image to a user through active or passive polarizing glasses.

The autostereoscopic display device provides the 3D image to the user using a barrier member or a lens member. The autostereoscopic display device provides the user with the 3D image having brightness typically lower than that of the stereoscopic display device.

### SUMMARY

The disclosure provides a display device that displays a three-dimensional image with improved brightness and resolution.

According to an exemplary embodiment, a display device includes a light source which emits a light, a transmissive display module which generates a two-dimensional (“2D”) image or a three-dimensional (“3D”) based on an operation mode thereof, and an optical control member disposed between the light source and the transmissive display module to provide the light emitted from the light source to the transmissive display module, where the optical control member includes a barrier member and a focus control member. In such an embodiment, the barrier member includes a plurality of barrier units including a polymer-dispersed liquid crystal layer to transmit or reflect the light incident thereto based on an arrangement of liquid crystal droplets therein, and each of the barrier unit forms a left-eye barrier pattern and a right-eye barrier pattern at different time points from each other in synchronization with the 3D image. In such an embodiment, the focus control member includes a plurality of lens units coupled to a surface of the barrier member and corresponding to the barrier units, where each of the lens units includes a lenticular lens surface, and the lens units provide the 3D image to different external positions from each other in synchronization with the left-eye barrier pattern and the right-eye barrier pattern.

In an exemplary embodiment, each of the barrier units may form a transmission pattern in synchronization with the 2D image.

In an exemplary embodiment, the 3D image may include a left-eye image and a right-eye image alternately displayed with the left-eye image, the barrier units may form the left-eye barrier pattern in synchronization with the left-eye image, and the barrier units may form the right-eye barrier pattern in synchronization with the right-eye image.

In an exemplary embodiment, the left-eye barrier pattern may include a plurality of left-eye sub-barrier patterns formed at the different time points, and the lens units may provide the left-eye image to positions of the different external positions in synchronization with the left-eye sub-barrier patterns.

In an exemplary embodiment, each of the barrier units may include a control electrode and a common electrode disposed opposite to the control electrode, the polymer-dispersed liquid crystal layer may be disposed between the control electrode and the common electrode, and the control electrode may include a first electrode and a second electrode spaced apart from the first electrode.

In an exemplary embodiment, the barrier units and the lens units may be arranged in a predetermined direction, each of the barrier unit may have a first width in the predetermined direction, and each of the lens unit may have a second width less than the first width in the predetermined direction.

In an exemplary embodiment, the lens units may include a first lens unit disposed at a center position in the predetermined direction and a second lens unit disposed at an outer position in the predetermined direction.

In an exemplary embodiment, the barrier units may include a first barrier unit corresponding to the first lens unit, and both ends of the first lens unit may overlap the first barrier unit.

In an exemplary embodiment, the barrier units may further include a second barrier unit corresponding to the second lens unit, one end of the second lens unit may overlap the second barrier unit, the other end of the second lens unit may not overlap the second barrier unit, and the one end of the second lens unit may be spaced apart further from the first lens unit than the other end of the second lens unit.

In an exemplary embodiment, each of the lens units may include a first electrode disposed on a base substrate, a body part coupled to the base substrate, where a surface of the body part defines the lenticular lens surface, and the lenticular lens surface defines a predetermined space with the base substrate, a polymer-dispersed liquid crystal mixture material disposed in the predetermined space to control an external focal length of a corresponding lens unit of the lens units, and a second electrode disposed on the body part.

In an exemplary embodiment, the base substrate may define a portion of the barrier member.

In an exemplary embodiment, the polymer-dispersed liquid crystal mixture material may include a polymer matrix and the liquid crystal droplets dispersed in the polymer matrix, and each of the liquid crystal droplets may include liquid crystal molecules.

In an exemplary embodiment, the polymer matrix may include a nano-polymer.

According to exemplary embodiments, where the optical control member includes the barrier member including the polymer-dispersed liquid crystal layer, a polarizing plate may be omitted, such that the amount of the light incident to the display module is increased, and the display module thereby displays the image at the high brightness.

In exemplary embodiments, when the focus control member is coupled to the barrier member, the light interference between the lens units is reduced. Each of the lens units may receive only the light provided from the corresponding barrier unit of the barrier units.

In exemplary embodiments, each of the barrier units has the width greater than that of the corresponding lens unit of the lens units. Among the barrier units, the barrier unit disposed at the outer position is shifted further to the left or right side than the corresponding lens unit. The shifted barrier unit shifts the external focus of the corresponding lens unit. Since the external focus is shifted with respect to positions, each of the lens units may provide the 3D image to the left eye or the right eye.

In exemplary embodiments, each of the lens units includes the nano-polymer-dispersed liquid crystal mixture material to control the focal length. When the nano-polymer-dispersed liquid crystal is aligned in the predetermined direction in synchronization with the 3D image, the lens units have the focusing function, and when the liquid crystals are not aligned in synchronization with the 2D image, the focusing function of the lens units disappears. Accordingly, the lens units have the lens function only when the 3D image is displayed and do not have the lens function when the 2D image is displayed, such that the lens units do not exert influence on a light path for the 2D image. Therefore, a moiré phenomenon of the 2D image is reduced and a viewing angle becomes widened. As a result, the display quality of the 2D image is improved.

### BRIEF DESCRIPTION OF THE DRAWINGS

The above and other features of the disclosure will become readily apparent by reference to the following detailed description when considered in conjunction with the accompanying drawings, in which:

FIG. 1 is an exploded perspective view showing an exemplary embodiment of a display device according to the invention;

FIG. 2 is a block diagram showing an exemplary embodiment of a display device according to the invention;

FIG. 3A is a view showing a left-eye image displayed in an exemplary embodiment of a display device according to the invention;

FIG. 3B is a view showing a right-eye image displayed in an exemplary embodiment of a display device according to the invention;

FIG. 4 is a timing diagram showing a three-dimensional mode of an exemplary embodiment of a display device according to the invention;

FIG. 5 is an enlarged view showing an exemplary embodiment of an optical control member according to the invention;

FIGS. 6A and 6B are views showing an exemplary embodiment of an optical control member driven in a three-dimensional mode, according to the invention;

FIG. 7 is a view showing a two-dimensional image displayed in an exemplary embodiment of a display device according to the invention;

FIGS. 8A to 8C are views showing a barrier unit and a lens unit of an exemplary embodiment of an optical control member according to the invention;

FIGS. 9A to 9D are views showing a three-dimensional operation of an exemplary embodiment of an optical control member according to the invention;

FIG. 10 is a block diagram showing an alternative exemplary embodiment of a display device according to the invention;

FIG. 11 is an enlarged view showing an alternative exemplary embodiment of an optical control member according to the invention;

FIGS. 12A and 12B are views showing a three-dimensional operation of an exemplary embodiment of an optical control member according to the invention;

FIG. 13 is a timing diagram showing a three-dimensional mode of an exemplary embodiment of a display device according to the invention;

FIG. 14 is a view showing an exemplary embodiment of an optical control member driven in a two-dimensional mode, according to the invention; and

FIG. 15 is a timing diagram showing a two-dimensional mode of an exemplary embodiment of a display device according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

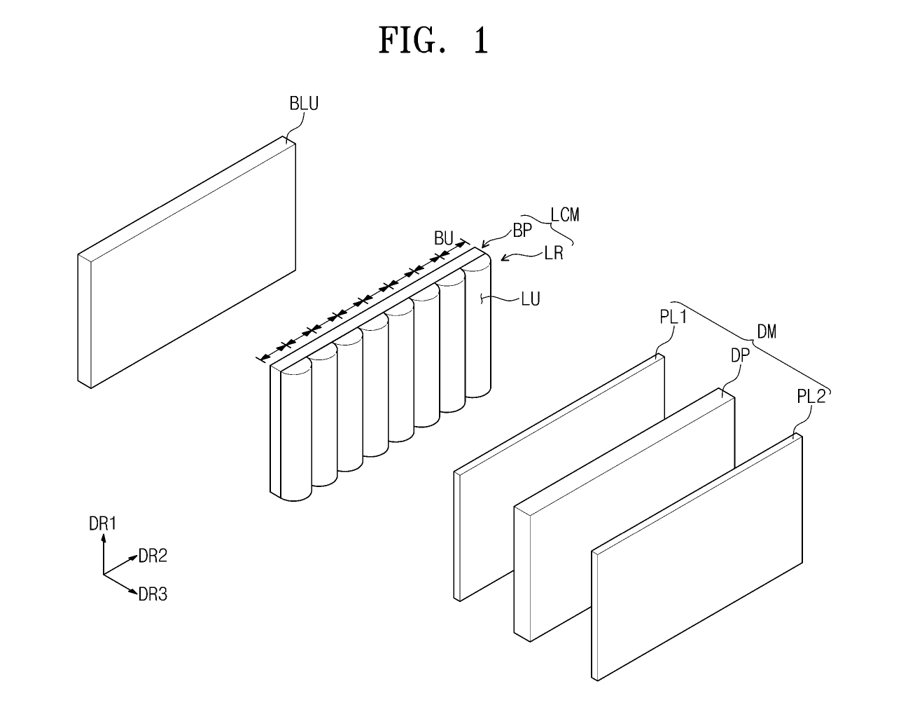

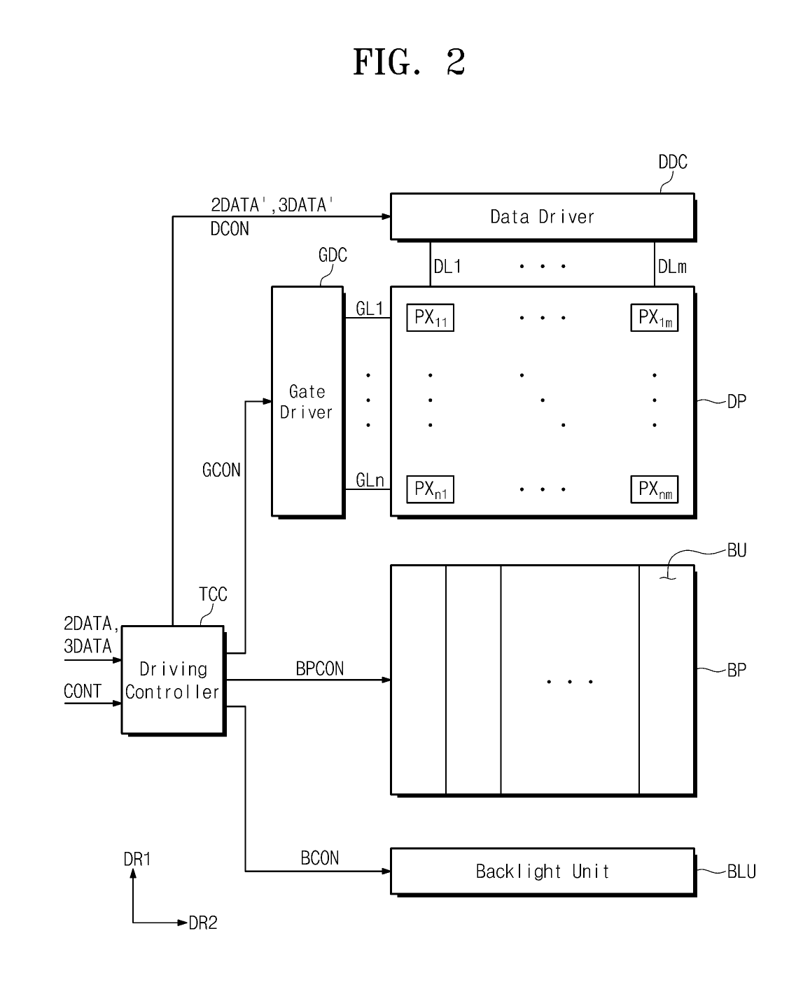

FIG. 1 is an exploded perspective view showing an exemplary embodiment of a display device according to the invention, and FIG. 2 is a block diagram showing an exemplary embodiment of a display device according to the invention.

Referring to FIG. 1, an exemplary embodiment of a display device includes a backlight module BLU, an optical control member LCM, and a display module DM. In FIG. 1, a first direction DR1 and a second direction DR2 define a front surface of the display device, and a third direction DR3 indicates a thickness direction of the display device. The optical control member LCM is disposed between the backlight module BLU and the display module DM in the third direction DR3.

The backlight module BLU emits light. The backlight module BLU may include a light source (not shown) and an optical sheet (not shown). The light source includes a plurality of light emitting devices, e.g., a light emitting diode, a cold cathode ray tube, etc. The light source is a direct-illumination type or an edge-illumination type.

In an exemplary embodiment, where the light source is a direct-illumination type, the light emitting devices of the direct-illumination type light source are disposed under the optical control member LCM. In an exemplary embodiment, where the light source is an edge-illumination type, the edge-illumination type light source further includes a light guide plate that guides the light emitted by the light emitting devices. The light emitting devices of the edge-illumination type light source provide the light to a side surface of the light guide plate. In such an embodiment, although not shown in figures, the light source may further include a circuit board.

The optical sheet includes a prism sheet and a diffusion sheet. The prism sheet condenses the light provided from the light source in a direction substantially vertical to the optical control member LCM. The diffusion sheet diffuses the light incident thereto to increase an amount of the light.

The backlight module BLU may further include a reflective plate. The reflective plate reflects the light leaked from the light guide plate or the light source such that the light travels to the light guide plate or the optical sheet. In an exemplary embodiment, where the light source is a direct-illumination type, the reflective sheet may be disposed under the light emitting devices of the direct-illumination type light source. In an exemplary embodiment, where the light source is an edge-illumination type, the reflective sheet may be disposed under the light guide plate of the edge-illumination type light source.

The optical control member LCM includes a barrier member BP and a focus control member LR. The focus control member LR is coupled to a front surface of the barrier member BP.

The barrier member BP includes a plurality of barrier units BU. Each of the barrier units BU controls a transmittance of the light incident thereto based on an operation mode of the display module DM. Each of the barrier units BU transmits the light regardless of areas thereof or selectively transmits/blocks the light passing through each area thereof. The barrier units BU extend substantially in the first direction DR1 and are arranged substantially in the second direction DR2.

The focus control member LR includes a plurality of lens units LU corresponding to the barrier units BU, respectively. Each of the lens units LU includes a lenticular lens surface. Each of the lens units LU provides the light incident thereto to external focuses. The lens units LU provides the incident light to different external positions from each other.

The display module DM includes a transmissive display panel DP and polarizers PL1 and PL2. In an exemplary embodiment, the display panel DP may be a liquid crystal display panel, but not being limited thereto. In an alternative exemplary embodiment, the display panel DP may be one of various transmissive display panels, such as an electrophoretic display panel and an electrowetting display panel, for example.

The polarizers PL1 and PL2 include a first polarizer PL1 and a second polarizer PL2, which face each other such that the display panel DP is disposed between the first and second polarizers PL1 and PL2. Each of the first and second polarizers PL1 and PL2 has an optical axis, i.e., a transmission axis and a blocking axis. The transmission axis of the first polarizer PL1 is substantially parallel to or substantially perpendicular to the transmission axis of the second polarizer PL2. In an alternative exemplary embodiment, the first polarizer PL1 or the second polarizer PL2 may be omitted.

The display module DM displays a two-dimensional (“2D”) image during a 2D mode and displays a three-dimensional (“3D”) image during a 3D mode. The 3D image includes a right-eye image and a left-eye image. The right-eye image and the left-eye image are provided to the different external positions from each other by the optical control member LCM. Accordingly, the right-eye image and the left-eye image are provided to the different external positions from each other outside the display device. The different external positions are virtual positions at which left and right eyes of the user are respectively positioned.

Referring to FIG. 2, the display panel DP includes a plurality of gate lines GL1 to GLn, a plurality of data lines DL1 to DLm, and a plurality of pixels PX11 to PXnm. Here, each of m and n are a natural number. Each of the pixels PX11 to PXnm is connected to a corresponding gate line of the gate lines GL1 to GLn and a corresponding data line of the data lines DL1 to DLm. The pixels PX11 to PXnm may be arranged substantially in a matrix form. The gate lines GL1 to GLn extend substantially in the second direction DR2 and are arranged substantially in the first direction DR1. The data lines DL1 to DLm cross the gate lines GL1 to GLn.

In one exemplary embodiment, for example, the display panel DP is the liquid crystal display panel including two base substrates and a liquid crystal layer interposed between the two base substrates. In such an embodiment, the gate lines GL1 to GLn and the data lines DL1 to DLm are disposed on one of the two base substrates.

Each of the pixels PX11 to PXnm includes a thin film transistor (not shown) connected to the corresponding gate line and the corresponding data line and a liquid crystal capacitor (not shown) connected to the thin film transistor. Electrodes of the thin film transistor and the liquid crystal capacitor are disposed on one of the two base substrates.

In an exemplary embodiment, as shown in FIG. 2, the display device further includes a circuit part to control the backlight module BLU, the display panel DP and the barrier member BP. The circuit part includes a driving controller TCC, a gate driver GDC, and a data driver DDC.

The driving controller TCC receives image signals 2DATA and 3DATA. The image signals include a 2D image signal 2DATA and a 3D image signal 3DATA. The driving controller TCC receives a control signal CONT corresponding to an operation mode of the display module DM. In one exemplary embodiment, for example, the control signal CONT includes control signals, e.g., a vertical synchronization signal, a horizontal synchronization signal and a plurality of clock signals, etc., corresponding to operation modes. The control signal CONT may include an operation mode selection signal that indicates the selected operation mode of the 2D and 3D operations modes.

The driving controller TCC applies a gate control signal GCON to the gate driver GDC. The gate control signal GCON includes a vertical start signal that starts an operation of the gate driver GDC and a gate clock signal that determines an output timing of the gate signal. The gate driver GDC applies gate signals to the gate lines GL1 to GLn.

The driving controller TCC applies a data control signal DCON to the data driver DDC. The driving controller TCC converts a data format of the image signals 2DATA and 3DATA to a data format appropriate to an interface between the data driver DDC and the driving controller TCC, and applies the converted image signals 2DATA′ and 3DATA′ to the data driver DDC.

The data driver DDC converts the image signals 2DATA′ and 3DATA′ to data signals using gamma voltages and applies the data signals to the data lines DL1 to DLm. The data control signal DCON includes a horizontal start signal that starts an operation of the data driver DDC, a polarity control signal that controls a polarity of the data signals, and a load signal that determines an output timing of the data signals.

Each of the pixels PX11 to PXnm is turned on in response to the gate signal applied to the corresponding gate line and receives the data signal applied to the corresponding data line. The liquid crystal capacitor of each of the pixels PX11 to PXnm is charged with the voltage corresponding to the corresponding data signal.

In such an embodiment, the driving controller TCC applies an operation control signal BPCON to the barrier member BP. In one exemplary embodiment, for example, the operation control signal BPCON includes a clock signal, a driving mode selection signal, etc. Although not shown in figures, the barrier units BU form a barrier pattern or a transmission pattern based on an operation of the barrier member BP.

The driving controller TCC applies a light source control signal BCON to the backlight module BLU. The light source is turned on or turned off based on the light source control signal BCON.

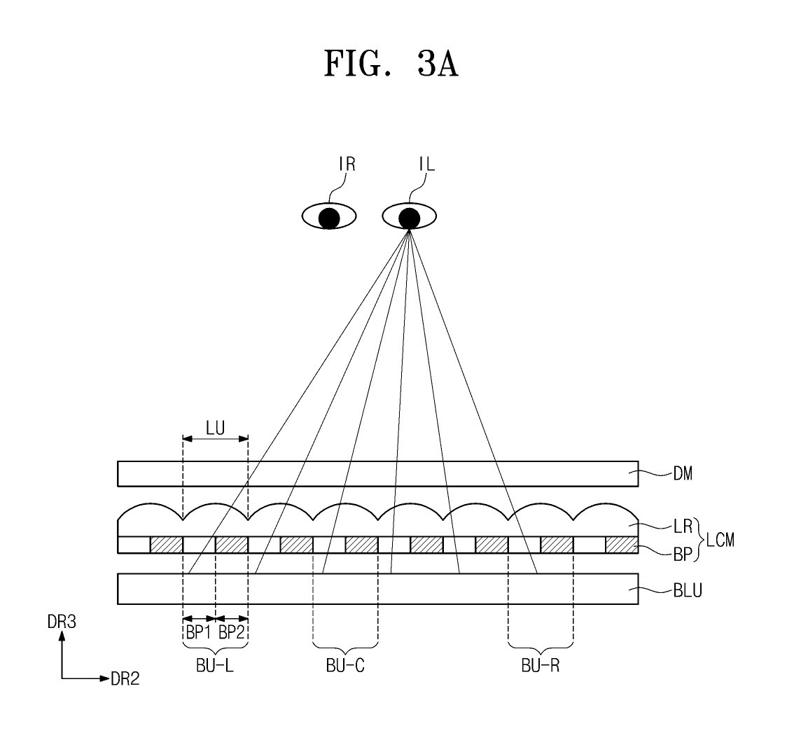

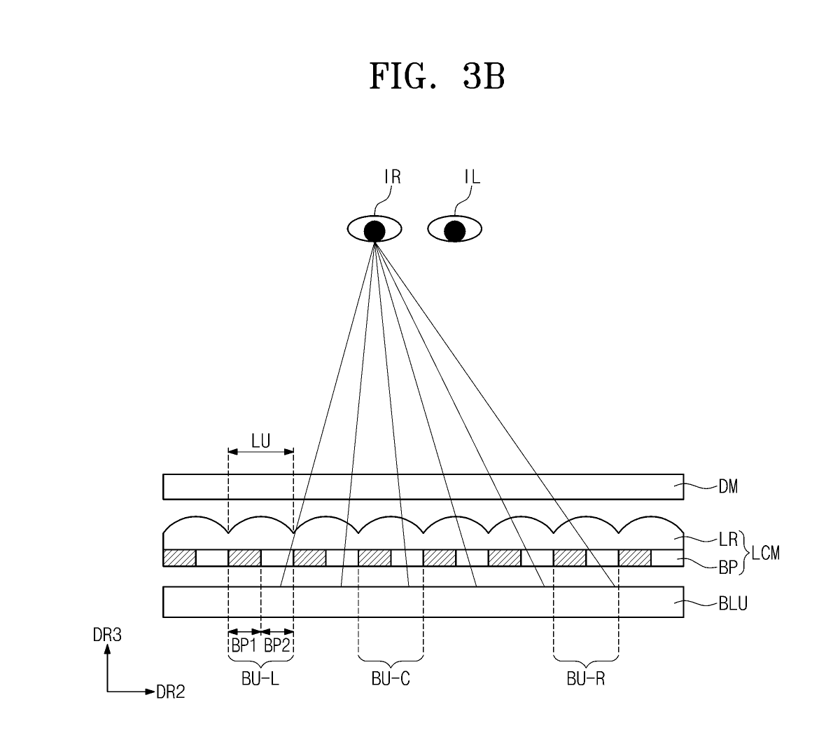

FIG. 3A is a view showing a left-eye image displayed in an exemplary embodiment of a display device according to the invention, FIG. 3B is a view showing a right-eye image displayed in an exemplary embodiment of the display device according to the invention, and FIG. 4 is a timing diagram showing the three-dimensional mode of an exemplary embodiment of the display device according to the invention. Hereinafter, an exemplary embodiment of the display device driven in the 3D mode will be described in detail with reference to FIGS. 3A, 3B and 4.

Referring to FIGS. 3A, 3B and 4, the display module DM driven in the 3D mode (hereinafter, referred to as “3D mode display module”) displays an image every frame periods Fn-L and Fn-R. Each of the frame periods Fn-L and Fn-R corresponds to a time period during which the gate lines GL1 to GLn are scanned by the gate signals. The frame periods Fn-L and Fn-R are determined based on a driving frequency of the display device.

The 3D mode display module DM alternately displays the left-eye image and the right-eye image. The 3D mode display module DM displays the left-eye image during one frame period Fn-L among the frame periods Fn-L and Fn-R and displays the right-eye image during the next frame period Fn-R following the one frame period Fn-L among the frame periods Fn-L and Fn-R. Hereinafter, the frame period in which the left-eye image is displayed is referred to as a “left-eye frame period Fn-L”, and the frame period in which the right-eye image is displayed is referred to as a “right-eye frame period Fn-R”.

During the left-eye frame period Fn-L, the pixels PX11 to PXnm (refer to FIG. 2) receive left-eye data signals DV-L through the data lines DL1 to DLm (refer to FIG. 2). During the right-eye frame period Fn-R, the pixels PX11 to PXnm (refer to FIG. 2) receive right-eye data signals DV-R through the data lines DL1 to DLm (refer to FIG. 2). Each of the pixels PX11 to PXnm transmits or blocks the light incident thereto in response to the left-eye data signals DV-L and the right-eye data signals DV-R.

Each of the barrier units, e.g., a left barrier unit BU-L, a center barrier unit BU-C and a right barrier unit BU-R, includes a first area BP1 and a second area BP2. Each of the first and second areas BP1 and BP2 defines the barrier pattern or the transmission pattern. Each of the first and second areas BP1 and BP2 defines the transmission pattern in an activation mode ON, and defines the barrier pattern in an inactivation mode OFF.

As shown in FIG. 3A, a left-eye barrier pattern is formed in synchronization with the left-eye image. The left-eye barrier pattern includes the transmission pattern defined, e.g., formed, in the first area BP1 and the barrier pattern defined, e.g., formed, in the second area BP2. The light provided from the backlight module BLU transmits through the first area BP1 and does not transmit through the second area BP2.

The lens unit LU provides the light transmitted through the first area BP1 of the left-eye barrier pattern to a first external focus (not shown). The light focused on the first external focus is provided to the left-eye IL of the user.

As shown in FIG. 3B, a right-eye barrier pattern is formed in synchronization with the right-eye image. The right-eye barrier pattern includes the barrier pattern formed in the first area BP1 and the transmission pattern formed in the second area BP2. The light provided from the backlight module BLU transmits through the second area BP2 and does not transmit through the first area BP1.

The lens unit LU provides the light transmitted through the second area BP2 of the left-eye barrier pattern to a second external focus (not shown) different from the first external focus. The light focused on the second external focus is provided to the right-eye IR of the user.

Accordingly, in such an embodiment, the user receives the left-eye image through the left-eye thereof during the left-eye frame period Fn-L and receives the right-eye image through the right-eye thereof during the right-eye frame period Fn-R. The user autostereoscopically perceives the left-eye image and the right-eye image, and thus the user perceives a three-dimensional image.

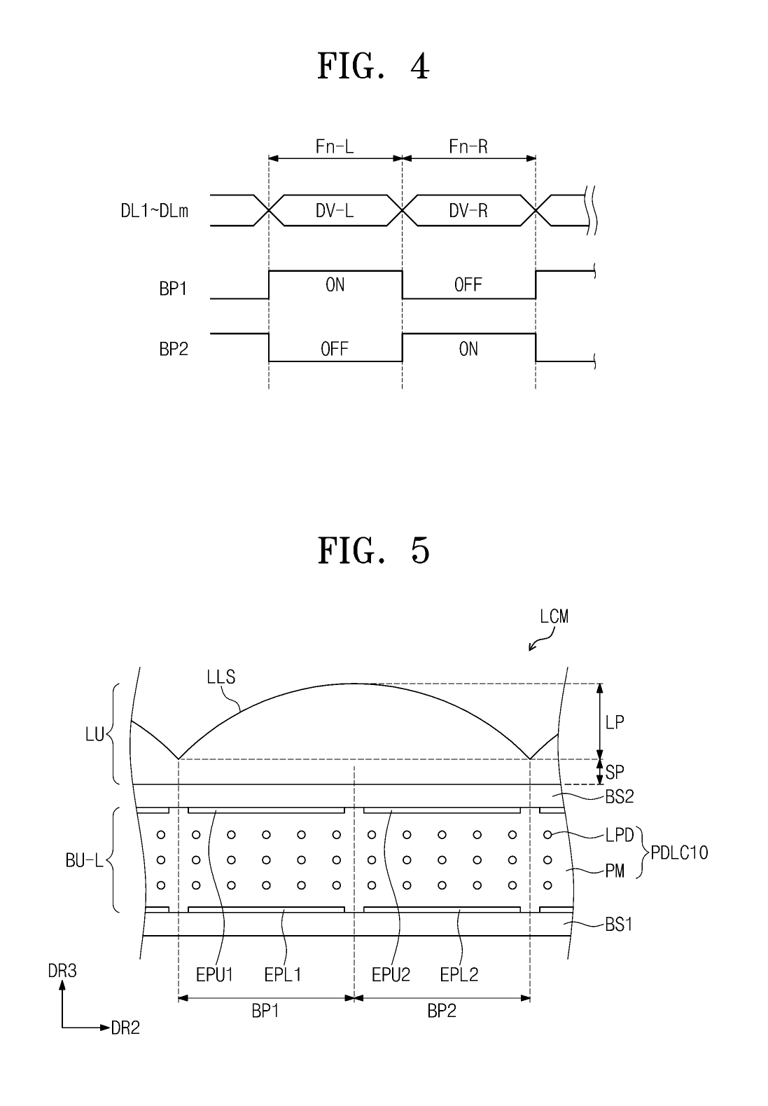

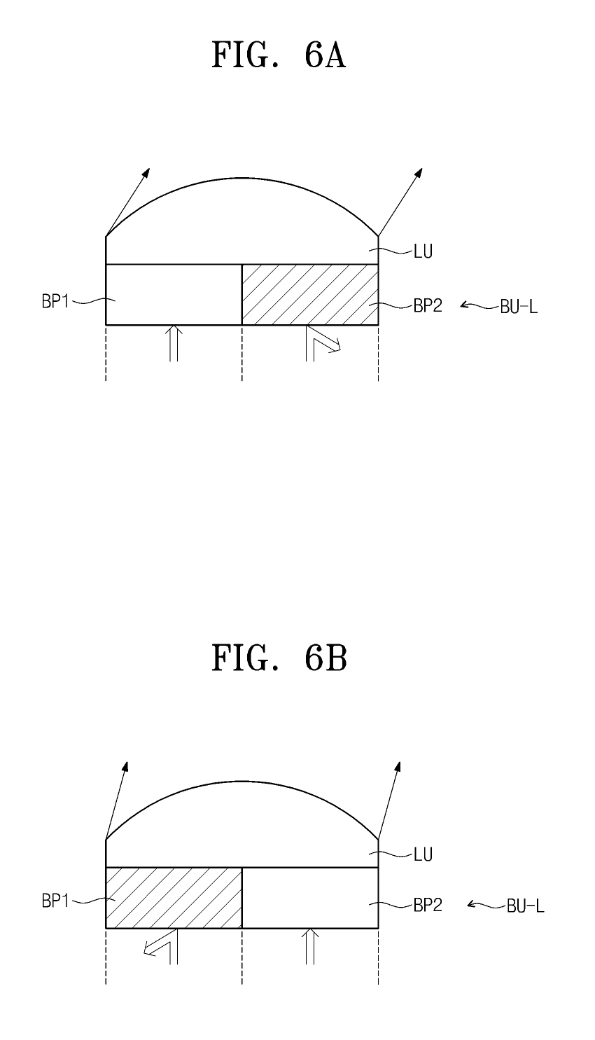

FIG. 5 is an enlarged view showing an exemplary embodiment of the optical control member according to the invention, and FIGS. 6A and 6B are views showing an exemplary embodiment of the optical control member driven in a three-dimensional mode, according to the invention. FIGS. 5, 6A and 6B show the left barrier unit BU-L disposed at a left side of the display device in FIGS. 3A and 3B and the lens unit LU corresponding to the left barrier unit BU-L. Hereinafter, an exemplary embodiment of the optical control member LCM will be described in detail with reference to FIGS. 5, 6A and 6B.

Referring to FIG. 5, the let barrier unit BU-L includes a lower base substrate BS1, an upper base substrate BS2 spaced apart from the lower base substrate BS1 in the third direction DR3, a polymer-dispersed liquid crystal layer PDLC10 disposed between the lower base substrate BS1 and the upper base substrate BS2, and electrodes EPL1, EPU1, EPL2 and EPU2 to apply an electric field to the polymer-dispersed liquid crystal layer PDLC10.

The lower base substrate BS1 and the upper base substrate BS2 are transparent. Each of the lower and upper base substrates BS1 and BS2 may be a glass substrate or a plastic substrate, for example. In an exemplary embodiment, the lower and upper base substrates BS1 and BS2 may be a functional optical member. In such an embodiment, the lens unit LU may function as the upper base substrate BS2.

A first lower electrode EPL1 and a second lower electrode EPL2 are disposed on an upper surface of the lower base substrate BS1 to respectively correspond to the first and second areas BP1 and BP2. A first upper electrode EPU1 and a second upper electrode EPU2 are disposed on a lower surface of the upper base substrate BS2 to respectively correspond to the first and second areas BP1 and BP2. The first and second lower electrodes EPL1 and EPL2, and the first and second upper electrodes EPU1 and EPU2 include a transparent metal oxide or a metal layer having a thickness through which the light transmits. Although not shown in figures, other functional layers may be further disposed on the upper surface of the lower base substrate BS1 and the lower surface of the upper base substrate BS2.

The lower electrodes EPL1 and EPL2 or the upper electrodes EPU1 and EPU2 may be a common electrode applied with a common voltage regardless of the operation mode of the barrier unit BU-L. In an exemplary embodiment, the upper electrodes EPU1 and EPU2 may be the common electrode. In such an embodiment, the lower electrodes EPL1 and EPL2 may be control electrodes applied with different voltages based on the operation mode of the barrier unit BU-L. When the voltage applied to the lower electrodes EPL1 and EPL2 is controlled, the electric field is partially formed in the polymer-dispersed liquid crystal layer PDLC10. Accordingly, the barrier pattern or the transmission pattern is selectively formed in the first and second areas BP1 and BP2. In an exemplary embodiment, the upper electrodes EPU1 and EPU2 may be integrally formed as a single unitary and individual unit. Although not shown in figures, the barrier member BP may further include a circuit part that receives the operation control signal BPCON and applies the driving voltage to the lower electrodes EPL1 and EPL2 and the upper electrodes EPU1 and EPU2.

The polymer-dispersed liquid crystal layer PDLC10 includes a polymer matrix PM and liquid crystal droplets LPD dispersed in the polymer matrix PM. Each of the liquid crystal droplets LPD includes liquid crystal molecules arranged in a predetermined direction. The directivity (e.g., a direction of the longitudinal axis) of the liquid crystal droplets LPD is determined based on the direction indicated by the liquid crystal molecules. In an exemplary embodiment, the liquid crystal droplets LPD are formed by phase separating a mixture of the liquid crystal molecules and an isotropic low-molecular material. IN such an embodiment, the phase separation process is performed on the mixture using an ultraviolet-ray irradiation method or a solvent drying method. The low-molecular material is polymerized during the phase separation process to form the polymer matrix.

When the electric field is not generated in the polymer-dispersed liquid crystal layer PDLC10, the liquid crystal droplets LPD are randomly oriented without being directed to a specific direction. When the liquid crystal droplets LPD are randomly oriented, the liquid crystal droplets LPD scatter the light incident thereto. Therefore, the light incident to the polymer-dispersed liquid crystal layer PDLC10 is reflected.

When the electric field is generated in the polymer-dispersed liquid crystal layer PDLC10, the liquid crystal droplets LPD are oriented in the predetermined direction. The polymer-dispersed liquid crystal layer PDLC10 transmits the light incident thereto since the liquid crystal droplets LPD are oriented in the predetermined direction. When an ordinary refractive index of the liquid crystal molecules is substantially the same as a refractive index of the polymer matrix PM, the transmittance of the incident light becomes a maximum value.

The barrier unit BU-L forms the barrier pattern or the transmission pattern using the optical property of the polymer-dispersed liquid crystal layer PDLC10 without a polarizing plate. In such an embodiment, where the polarizing plate is omitted, an amount of the light incident to the display module DM (refer to FIG. 1) is increased. Thus, the display module DM displays the image at a high brightness.

In an exemplary embodiment, as shown in FIG. 5, the lens unit LU includes a plane part SP and a lens part LP. The plane part SP may be coupled to an upper surface of the upper base substrate BS2 by an adhesive. The plane part SP should not be limited to the scale shown in FIG. 5. The plane part SP may have a thickness greater than a thickness of the barrier unit BU-L. In an exemplary embodiment, the plane part SP may function as the upper base substrate BS2.

The lens part LP includes the lenticular lens surface LLS. The plane part SP may be integrally formed with the lens part LP. The lens unit LU includes a transparent plastic resin. In an exemplary embodiment, the lens part LP is attached to the upper surface of the plane part SP by an adhesive. In an exemplary embodiment, the plane part SP may be omitted, and the lens part LP may be directly attached to the upper surface of the upper base substrate BS2.

As described above, since the lens unit LU is coupled to the barrier unit BU-L, the lens unit LU may receive only the light provided from the corresponding barrier unit BU-L. When a distance between the lens unit LU and the barrier unit BU-L is minimized, the light exiting from the barrier unit BU-L is provided to only the corresponding lens unit LU without being diffused to adjacent lens units. Accordingly, a light interference between the lens units is reduced.

Hereinafter, an exemplary embodiment of a method of forming the left-eye barrier pattern will be described with reference to FIGS. 5 and 6A. The first lower electrode EPL1 and the first upper electrode EPU1 are applied with different voltages from each other, and the second lower electrode EPL1 and the second upper electrode EPU1 are applied with the same voltage to form the left-eye barrier pattern. When the common voltage is applied to the first upper electrode EPU1, the second lower electrode PEL2 and the second upper electrode EPU2, the first upper electrode EPU1, the second lower electrode PEL2 and the second upper electrode EPU2 have the same electric potential.

When the electric field is generated in the first area BP1, the liquid crystal droplets corresponding to the first area BP1 are aligned in the predetermined direction such that the transmission pattern is formed in the first area BP1.

Since the electric field is not generated in the second area BP2, the barrier pattern is formed in the second area BP2. The reflected light is reflected by the optical sheet (not shown) or the reflective plate (not shown), which is disposed under the optical control member LCM, and then re-incident to the first area BP1. The lens unit LU provides the light provided from the first area BP1 to the left eye IL (refer to FIG. 3A) of the user. As described above, since the light extinction in the barrier unit BU-L is reduced, the light efficiency is improved.

Hereinafter, an exemplary embodiment of a method of forming the right-eye barrier pattern will be described in detail with reference to FIGS. 5 and 6B. The first lower electrode EPL1 and the first upper electrode EPU1 are applied with the same voltage, and the second lower electrode EPL2 and the second upper electrode EPU2 are applied with different voltages from each other to form the right-eye barrier pattern. In an exemplary embodiment, the first upper electrode EPU1, the first lower electrode EPL1 and the second upper electrode EPU2 are applied with the common voltage.

Since the electric field is not generated in the first area BP1, the barrier pattern is formed in the first area BP1, and the transmission pattern is formed in the second area BP2 since the electric field is generated in the second area BP2. The lens unit LU provides the light provided from the second area BP2 to the right eye IR (refer to FIG. 3B) of the user.

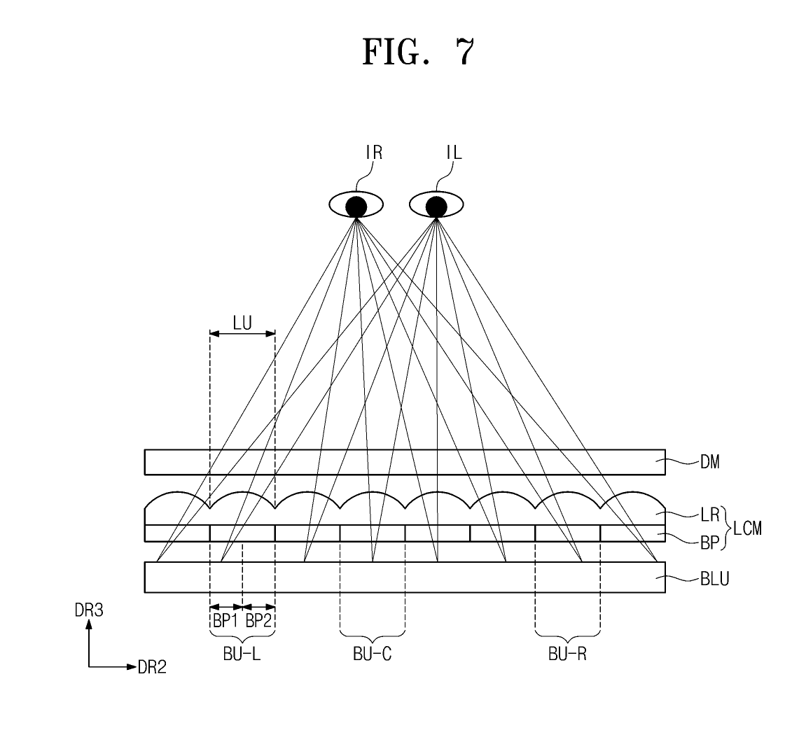

FIG. 7 is a view showing the 2D image displayed in an exemplary embodiment of the display device according to the invention.

The display module DM driven in the 2D mode (hereinafter, referred to as “2D mode display module”) displays the 2D image every frame period. The 2D data signals are applied to the pixels PX11 to PXnm (refer to FIG. 2) every frame period. In one exemplary embodiment, for example, the frame period of the 2D mode corresponds to the right-eye frame period or the left-eye frame period following the right-eye frame period of the 3D mode. In such an embodiment, the driving frequency in the 2D mode of the display device may be lower than the driving frequency in the 3D mode of the display device.

The transmission pattern is formed in each of the barrier units BU in synchronization with the 2D image. In an exemplary embodiment, the transmission pattern is formed in each of the first and second areas BP1 and BP2. The first lower electrode EPL1 and the first upper electrode EPU1 are applied with different voltages from each other, and the second lower electrode EPL2 and the second upper electrode EPU2 are applied with different voltages from each other. The light provided from the backlight module BLU is provided to the lens units LU after passing through the barrier units BU.

The lens units LU provides the incident light from the backlight module BLU to different external positions. The 2D image is provided to the right eye IR and the left eye IL of the user.

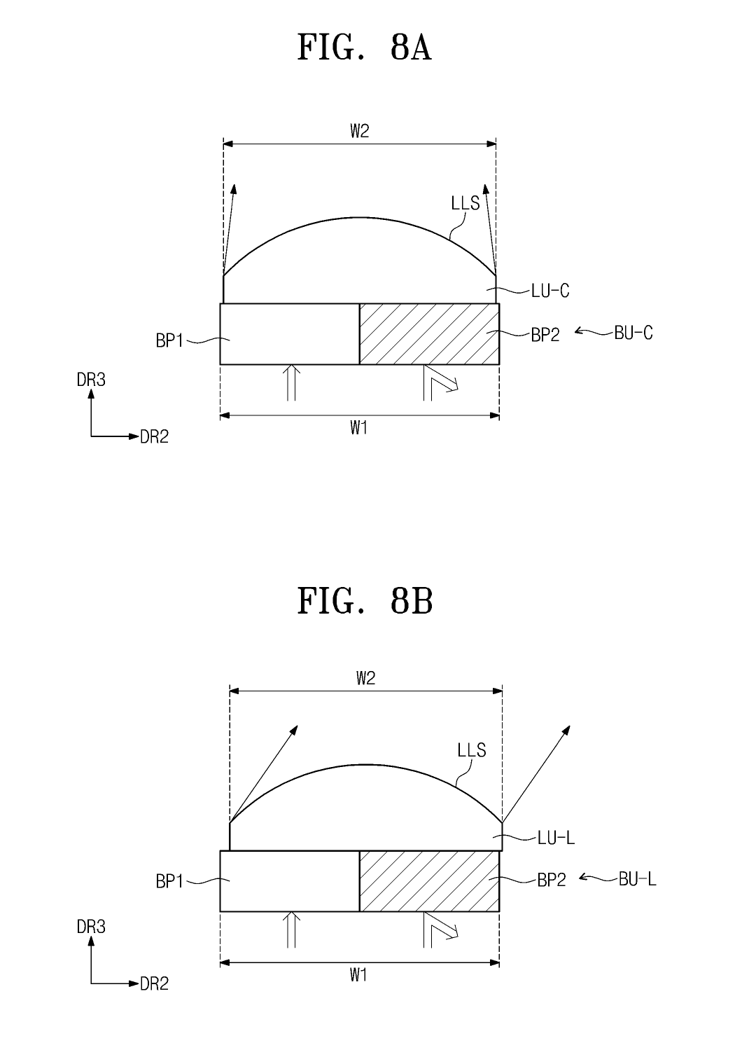

FIGS. 8A to 8C are views showing the barrier unit and the lens unit of an exemplary embodiment of the optical control member according to the invention. Hereinafter, an exemplary embodiment of the optical control member LCM will be described in detail with reference to FIGS. 8A to 8C. In FIGS. 8A to 8C, the same reference numerals denote the same elements in FIGS. 1 to 7, and thus detailed descriptions of the same elements will be omitted.

FIGS. 8A to 8C show the center barrier unit BU-C, the left barrier unit BU-L and the right barrier unit BU-R, respectively, among the barrier units in which the left-eye barrier pattern shown in FIG. 3A is defined. The center barrier unit BU-C shown in FIG. 8A (hereinafter, also referred to as a “first barrier unit”) is disposed at a center portion of the display device in the second direction DR2. The left barrier unit BU-L (hereinafter, also referred to as a “second barrier unit”) and the right barrier unit BU-R (hereinafter, also referred to as a “third barrier unit”) respectively shown in FIGS. 8B and 8C are respectively disposed at outer portions of the display device in the second direction DR2. As shown in FIG. 3A, the second barrier unit BU-L is disposed at a left portion, and the third barrier unit BU-R is disposed at a right portion.

The first, second and third barrier units BU-C, BU-L and BU-C have a first width W1 in the second direction DR2. The first, second and third barrier units BU-C, BU-L and BU-C may have substantially the same width as each other.

The first, second and third lens units LU-C, LU-L and LU-R respectively corresponding to the first, second and third barrier units BU-C, BU-L and BU-C, each of which has a second width W2 in the second direction DR2. The first, second and third lens units LU-C, LU-L and LU-R have substantially the same width as each other. The second width W2 may be less than the first width W1.

In such an embodiment, the arrangements of the lens units and the barrier units are changed based on positions in the second direction DR2 to provide the left-eye image to the external specific position spaced apart from the center portion of the display device in the third direction DR3.

Referring to FIG. 8A, the first lens unit LU-C is aligned to correspond to the first barrier unit BU-C. A center portion of the first lens unit LU-C matches with a center portion of the first barrier unit BU-C. Both ends of the first lens unit LU-C overlap the first barrier unit BU-C. The light exiting from the transmission pattern formed in the first area BP1 of the first barrier unit BU-C is substantially vertically incident to the first lens unit LU-C. The first lens unit LU-C provides the light exiting from the transmission pattern of the first barrier unit BU-C to the left eye IL (refer to FIG. 3A) of the user.

In such an embodiment, the second and third barrier units BU-L and BU-R are shifted to left and right sides from the second and third lens units LU-L and LU-R, respectively. The light exiting from the second and third barrier units BU-L and BU-R may be obliquely or inclinedly incident to the second and third lens units LU-L and LU-R, respectively.

Referring to FIG. 8B, one end (e.g., a left side end) of the second lens unit LU-L overlaps the second barrier unit BU-L, and the other end (e.g., a right side end) of the second lens unit LU-L does not overlap the second barrier unit BU-L. The one end of the second lens unit LU-L is spaced farther away from the first lens unit LU-C than the other end of the second lens unit LU-L. Referring to FIG. 8C, one end (e.g., a right side end) of the third lens unit LU-R, which overlaps the third barrier unit BU-R, is spaced farther away from the first lens unit LU-C than the other end (e.g., a left side end) of the third lens unit LU-R, which does not overlap the third barrier unit BU-R.

In such an embodiment, as described above, a center of the second barrier unit BU-L is disposed in a position shifted to the left side with respect to a center of the second lens unit LU-L, such that the external focus of the second lens unit LU-L is further shifted to the right side than the external focus of the first lens unit LU-C. In such an embodiment, a center of the third barrier unit BU-R is disposed in a position shifted to the right side with respect to a center of the third lens unit LU-R, such that the external focus of the third lens unit LU-R is further shifted to the left side than the external focus of the first lens unit LU-C. When the external focuses of the second and third lens units LU-L and LU-R are shifted, the first, second and third lens units LU-C, LU-R and LU-L may focus the left-eye image on the left eye IL (refer to FIG. 3A) of the user regardless of the positions of the first, second and third lens units LU-C, LU-R and LU-L.

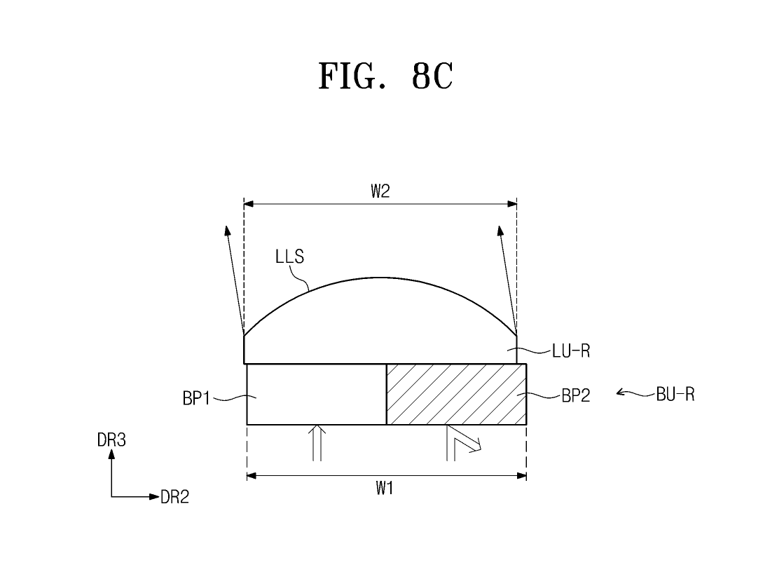

FIGS. 9A to 9D are views showing a 3D operation of an exemplary embodiment of the optical control member according to the invention. FIGS. 9A to 9D show one barrier unit of an exemplary embodiment of the optical control member, which is disposed at the left side from a center of the optical control member in the second direction DR2. The optical control member shown in FIGS. 9A to 9D is substantially the same as the optical control member shown in FIGS. 1 to 8C except for the barrier unit. The same or like elements shown in FIGS. 9A to 9D have been labeled with the same reference characters as used above to describe the exemplary embodiments of the optical control member shown in FIGS. 1 to 8C, and any repetitive detailed description thereof will hereinafter be omitted or simplified.

Referring to FIGS. 9A to 9D, in an exemplary embodiment, the barrier unit BU-L10 includes first and second areas BP1 and BP2. In an exemplary embodiment, the first area BP1 may include first and second sub-areas BP1-1 and BP1-2, and the second area BP2 may include third and fourth sub-areas BP2-1 and BP2-2.

Each of the first, second, third and fourth sub-areas BP1-1, BP1-2, BP2-1 and BP2-2 individually defines the barrier pattern or the transmission pattern, independently of each other. Although not shown in figures, electrodes are disposed in each of the first, second, third and fourth sub-areas BP1-1, BP1-2, BP2-1 and BP2-2 to individually form the electric field. As shown in FIGS. 9A and 9B, first and second left-eye barrier patterns are formed in synchronization with the left-eye image. The first left-eye barrier pattern includes the transmission pattern formed in the first sub-area BP1-1, and the second left-eye barrier pattern includes the transmission pattern formed in the second sub-area BP1-2. The first and second left-eye barrier patterns provide the left-eye image to different external positions from each other. The external positions are virtual positions in which the left eye of the user may be positioned.

As shown in FIGS. 9C and 9D, first and second right-eye barrier patterns are formed in synchronization with the right-eye image. The first right-eye barrier pattern includes the transmission pattern formed in the third sub-area BP2-1 and the second right-eye barrier pattern includes the transmission pattern formed in the fourth sub-area BP2-2. The first and second right-eye barrier patterns provide the right-eye image to different external positions from each other. The external positions are virtual positions in which the right eye of the user may be positioned.

As shown in FIGS. 9A to 9D, when the barrier unit BU-L10 forms the transmission patterns, the display panel DP sequentially displays the first left-eye image, the second left-eye image, the first right-eye image and the second right-eye image. The user may perceive the 3D image obtained by combining the first left-eye image and the first right-eye image focused through the first left-eye barrier pattern and the first right-eye barrier pattern at an arbitrary position. The user may perceive the 3D image obtained by combining the second left-eye image and the second right-eye image focused through the second left-eye barrier pattern and the second right-eye barrier pattern at another arbitrary position.

As shown in FIGS. 9A and 9C, the first and second left-eye barrier patterns are formed in synchronization with the left-eye image. The first left-eye barrier pattern includes the transmission pattern formed in the first sub-area BP1-1 and the second left-eye barrier pattern includes the transmission pattern formed in the third sub-area BP2-1. The first and second left-eye barrier patterns provide the left-eye to different external positions. The external positions are virtual positions at which the left eyes of two users are positioned.

As shown in FIGS. 9B and 9D, the first and second right-eye barrier patterns are formed in synchronization with the right-eye image. The first right-eye barrier pattern includes the transmission pattern formed in the second sub-area BP1-2 and the second right-eye barrier pattern includes the transmission pattern formed in the fourth sub-area BP2-2. The first and second right-eye barrier patterns provide the right-eye to different external positions. The external positions are virtual positions at which the right eyes of the two users are positioned.

As shown in FIGS. 9A to 9D, when the barrier unit BU-L10 forms the transmission patterns, the display panel DP sequentially displays the first left-eye image, the first right-eye image, the second left-eye image and the second right-eye image. A first user perceives the 3D image at a first position by the first left-eye image provided through the first left-eye barrier pattern shown in FIG. 9A and the first right-eye image provided through the first right-eye barrier pattern shown in FIG. 9B. A second user perceives the 3D image at a second position different from the first position by the second left-eye image provided through the second left-eye barrier pattern shown in FIG. 9C and the second right-eye image provided through the second right-eye barrier pattern shown in FIG. 9D. In an exemplary embodiment, the first left-eye image and the second left-eye image are substantially the same as each other, and the first right-eye image and the second right-eye image are substantially the same as each other.

In an exemplary embodiment, each of the first and second areas BP1 and BP2 may include a plurality of sub-areas to provide the image to a plurality of external positions.

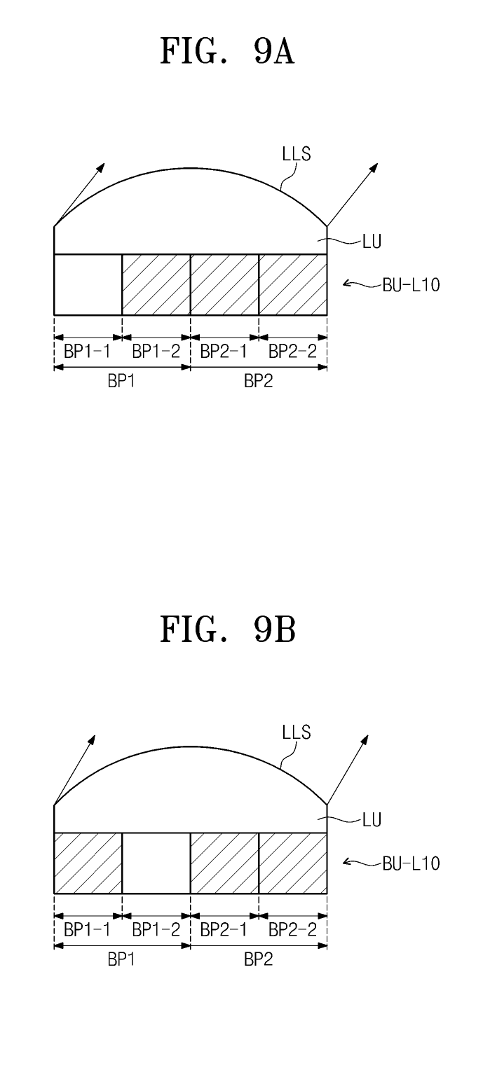

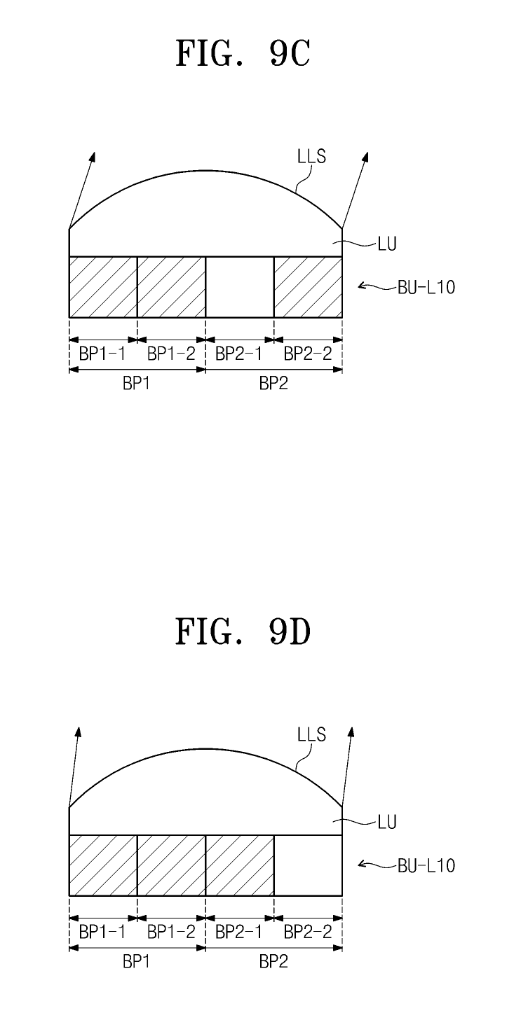

FIG. 10 is a block diagram showing an alternative exemplary embodiment of a display device according to the invention, and FIG. 11 is an enlarged view showing an alternative exemplary embodiment of an optical control member according to the invention. The display device shown in FIGS. 10 and 11 is substantially the same as the display device shown in FIGS. 1 to 9D except for a focus control member. The same or like elements shown in FIGS. 10 and 11 have been labeled with the same reference characters as used above to describe the exemplary embodiments of the display device shown in FIGS. 1 to 9C, and any repetitive detailed description thereof will hereinafter be omitted or simplified.

Referring to FIG. 10, an exemplary embodiment of the display device includes a focus control member LR10 to control an external focal length based on an operation mode thereof. The focus control member LR10 includes a plurality of lens units LU10. Each of the lens units LU10 provides the incident light to different focuses in response to the electric field applied thereto.

A driving controller TCC applies an operation control signal LRCON to the focus control member LR10. Although not shown in figures, the focus control member LR10 further includes a circuit part that receives the operation control signal LRCON and applies the driving voltage to electrodes of the focus control member LR10.

Referring to FIG. 11, the lens unit LU10 is disposed on a front surface of the barrier unit BU-L. The barrier unit BU-L is schematically shown in FIG. 11.

The lens unit LU10 includes a base substrate BS, a body part BM coupled to the base substrate BS to define a predetermined space, and a polymer-dispersed liquid crystal mixture material PDLC20. In an alternative exemplary embodiment, the base substrate BS may be omitted, and the barrier unit BU-L may function as the base substrate BS.

In an exemplary embodiment, the lens unit LU10 includes a first electrode ELL and a second electrode ELU to form the electric field. The predetermined space is defined by an upper surface of the base substrate BS and a lenticular lens surface LLS10 of the body part BM. The first electrode ELL is disposed on the upper surface of the base substrate BS10, and the second electrode ELU is disposed on an outer surface of the body part BM. In an exemplary embodiment, the second electrode ELU may be disposed on an upper surface of the body part BM.

In an exemplary embodiment, the lens unit LU10 further includes a protective layer PL to protect the second electrode ELU. The protective layer PL may be a transparent organic/inorganic layer or a protective film attached to the upper surface of the body part BM. Although not shown in figures, another functional layer may be further disposed on the upper surface of the base substrate BS10 and the lenticular lens surface LLS10.

In an exemplary embodiment, the second electrode ELU may be disposed on the lenticular lens surface LLS10. In an exemplary embodiment, the second electrode ELU may be disposed on a layer different from a layer on which the first electrode ELL is disposed of the base substrate BS10. In an alternative exemplary embodiment, the protective layer PL may be omitted. In an alternative exemplary embodiment, where the base substrate BS is omitted, the first electrode ELL may be disposed on an upper surface of the barrier unit BU-L.

The polymer-dispersed liquid crystal mixture material PDLC20 includes a polymer matrix PM-N and liquid crystal droplets LPD dispersed in the polymer matrix PM-N. The polymer matrix PM-N may include a nano-polymer.

In an exemplary embodiment, the liquid crystal droplets LPD may be provided, e.g., formed, by phase separating a mixture of the liquid crystal molecules and the polymer matrix PM-N. The mixture includes about 35 weight percent (wt %) of liquid crystal molecules and about 65 wt % of polymer matrix PM-N based on a total weight of the mixture. The polymer matrix PM-N may be an ultraviolet-ray curable polymer. The liquid crystal molecules may be nematic liquid crystal molecules.

The refractive index of the polymer matrix PM-N may be substantially equal to the refractive index of the liquid crystal molecules. In one exemplary embodiment, for example, the polymer matrix PM-N has the refractive index of about 1.524, and the liquid crystal molecules have the ordinary refractive index of about 1.523.

In an exemplary embodiment, the body part BM may include the same polymer as that of the polymer matrix PM-N. In such an embodiment, the body part BM may be manufactured using an ultraviolet-ray curable nano-polymer having a refractive index of about 1.524. In an exemplary embodiment, the body part BM may include another polymer having substantially the same refractive index as that of the polymer matrix PM-N.

When the electric field is not generated in the polymer-dispersed liquid crystal mixture material PDLC20, the liquid crystal droplets are aligned in an arbitrary direction. When the liquid crystal droplets are aligned in arbitrary directions, an effective refractive index of the polymer-dispersed liquid crystal mixture material PDLC20 is greater than the refractive index of the body part BM. Therefore, a phase profile of the light passing through the lens unit LU10 becomes substantially similar to a phase profile of the lenticular lens surface. The lens unit LU10 provides the light incident thereto to the external focus. The incident light focused on the external focus is provided to the left or right eye of the user.

When the electric field is formed in the polymer-dispersed liquid crystal layer PDLC10, the liquid crystal droplets LPD are aligned in a predetermined direction. In one exemplary embodiment, for example, the liquid crystal droplets LPD are aligned in a direction substantially parallel to the electric field. The electric field is formed by applying different voltages to the first and second electrodes ELL and ELU, respectively. In an exemplary embodiment, a vertical electric field may be generated in the polymer-dispersed liquid crystal layer PDLC10.

When the liquid crystal droplets LPD are aligned in the predetermined direction, the effective refractive index of the polymer-dispersed liquid crystal mixture material PDLC20 defined on a surface substantially vertical to the electric field is reduced. In an exemplary embodiment, the surface substantially vertical to the electric field may be a surface substantially parallel to the upper surface of the base substrate BS. When the effective refractive index of the polymer-dispersed liquid crystal mixture material PDLC20 is reduced, a phase profile gradient of the light passing through the lens unit LU10 is reduced. Thus, the focusing function of the lens unit LU10 is deteriorated.

When the effective refractive index of the polymer-dispersed liquid crystal mixture material PDLC20 is substantially equal to the refractive index of the body part BM, the phase profile of the light passing through the lens unit LU10 becomes substantially similar to the phase profile of the upper surface of the body part BM such that the lens unit LU10 may not perform the focusing function thereof.

The external focal length of the lens unit LU10 when the liquid crystal droplets are aligned in the predetermined direction is substantially greater than the external focal length of the lens unit LU10 when the liquid crystal droplets are aligned in the arbitrary direction. In one exemplary embodiment, for example, the external focal length of the lens unit LU10 may be infinite when the liquid crystal droplets are completely aligned in the predetermined direction.

The external focal length may be controlled by controlling an intensity of the electric field generated in the polymer-dispersed liquid crystal layer PDLC10. The external focal length may be increased by forming relatively weak electric field in the polymer-dispersed liquid crystal layer PDLC10 compared to the external focal length when the electric field is not generated in the polymer-dispersed liquid crystal mixture material PDLC20

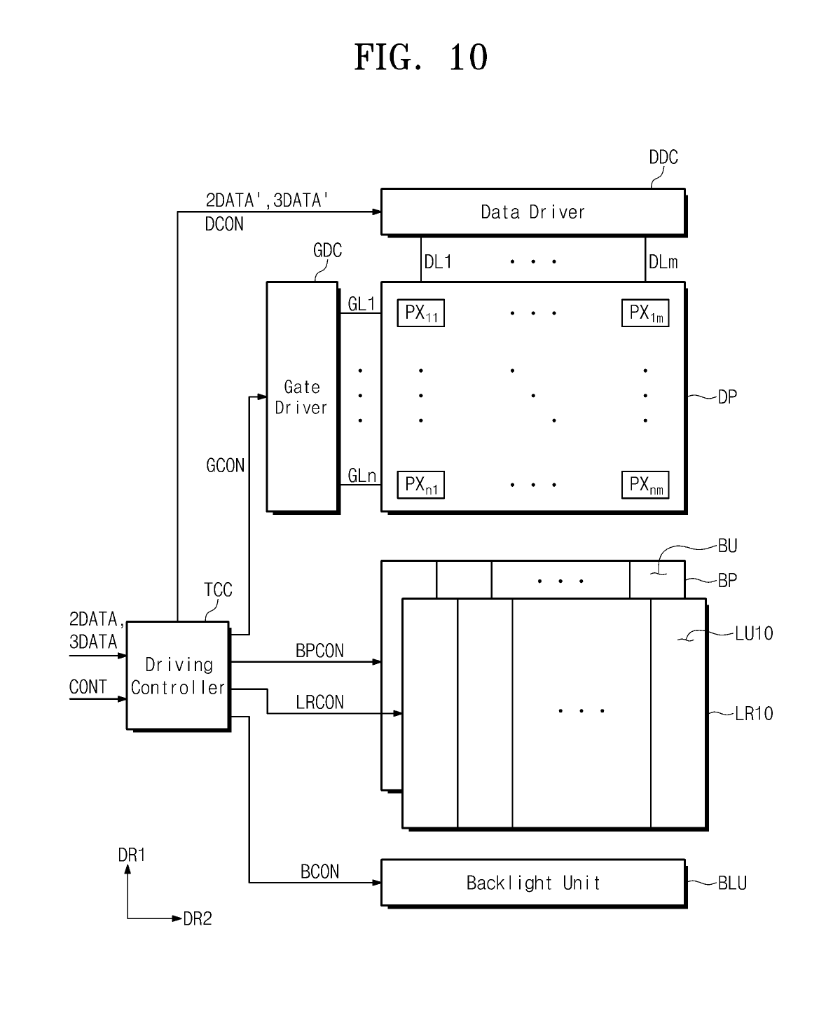

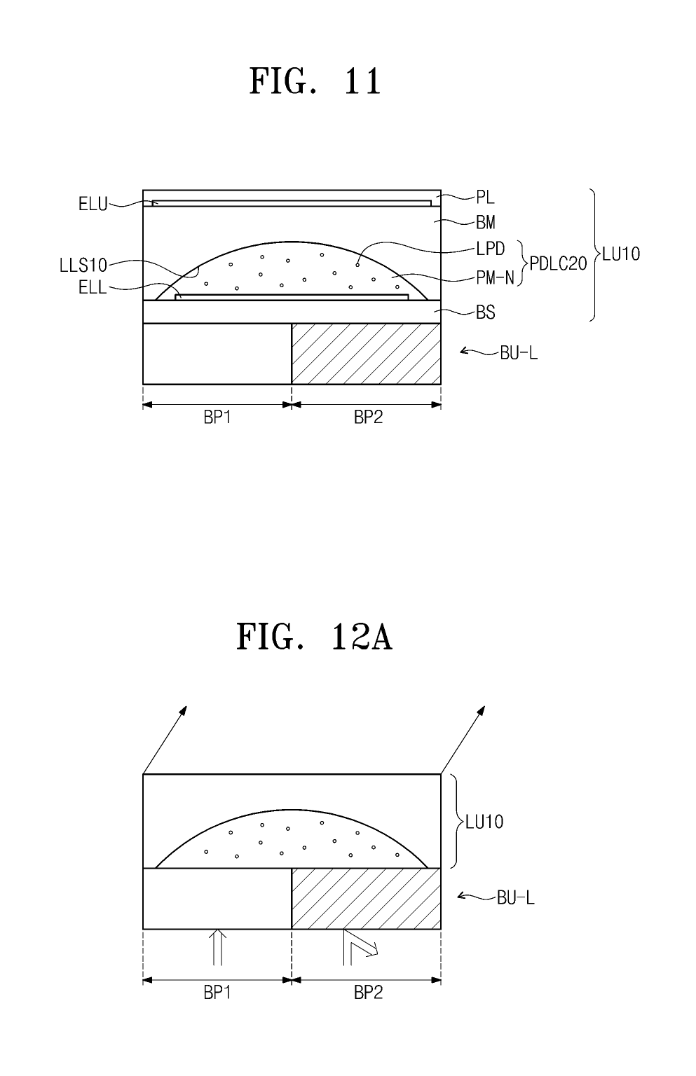

FIGS. 12A and 12B are views showing a 3D operation of an exemplary embodiment of an optical control member according to the invention, and FIG. 13 is a timing diagram showing a 3D mode of an exemplary embodiment of a display device according to the invention. FIGS. 12A, 12B and 13 show an exemplary embodiment of the barrier unit BL-U disposed at the left side and the lens unit LU10 corresponding to the barrier unit BL-U.

The barrier unit BL-U forms the left-eye barrier pattern during the left-eye frame period Fn-L and forms the right-eye barrier pattern during the right-eye frame period Fn-R. During the left-eye frame period Fn-L, the first area BP1 is driven in the activation mode ON and the second area BP2 is driven in the inactivation mode OFF. During the right-eye frame period Fn-R, the first area BP1 is driven in the inactivation mode OFF and the second area BP2 is driven in the activation mode ON.

When the display module DM is driven in the 3D mode, the lens unit LU10 is driven in the inactivation mode OFF. The first and second electrodes ELL and ELU have substantially the same electric potential. When the first and second electrodes ELL and ELU are applied with substantially the same voltage or floated, the electric field is not generated between the first and second electrodes ELL and ELU.

As shown in FIG. 12A, the lens unit LU10 provides the incident light provided from the first area BP1 to a first external focus (not shown) during the left-eye frame period Fn-L. The incident light focused on the first external focus is provided to the left eye IL (refer to FIG. 3A) of the user. As shown in FIG. 12B, the lens unit LU10 provides the incident light provided from the second area BP2 to a second external focus (not shown) during the right-eye frame period Fn-R. The incident light focused on the second external focus is provided to the right eye IR (refer to FIG. 3A) of the user.

When the display module DM is driven in the 3D mode, the lens unit LU10 may be driven in a half-activation mode to increase the external focal length of the lens unit LU10. The electric field formed between the first and second electrodes ELL and ELU during the half-activation mode is weaker than the electric field formed between the first and second electrodes ELL and ELU during the activation mode ON.

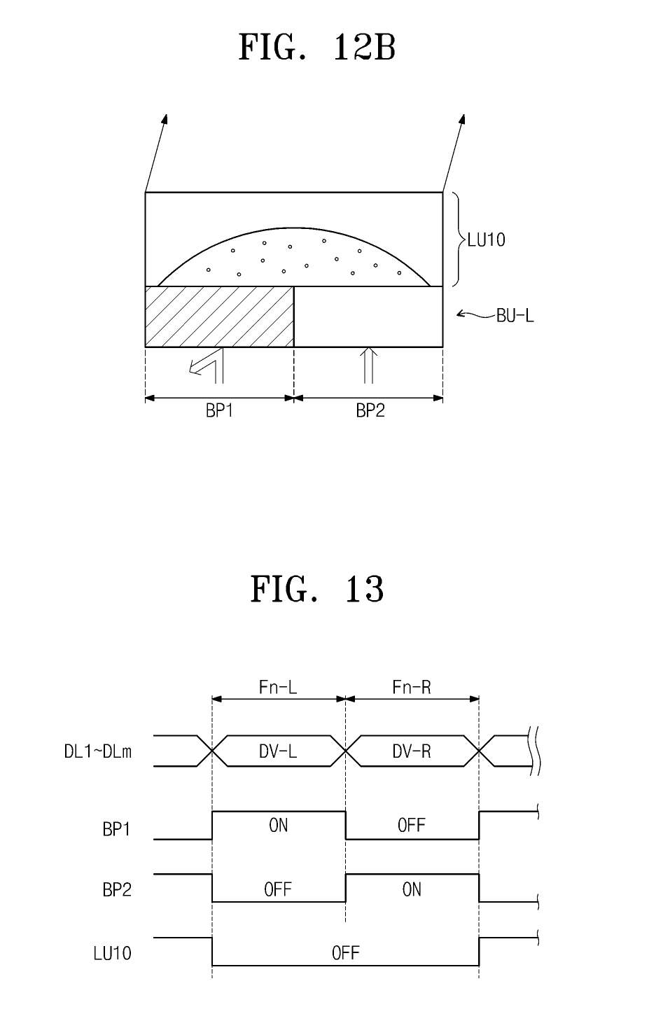

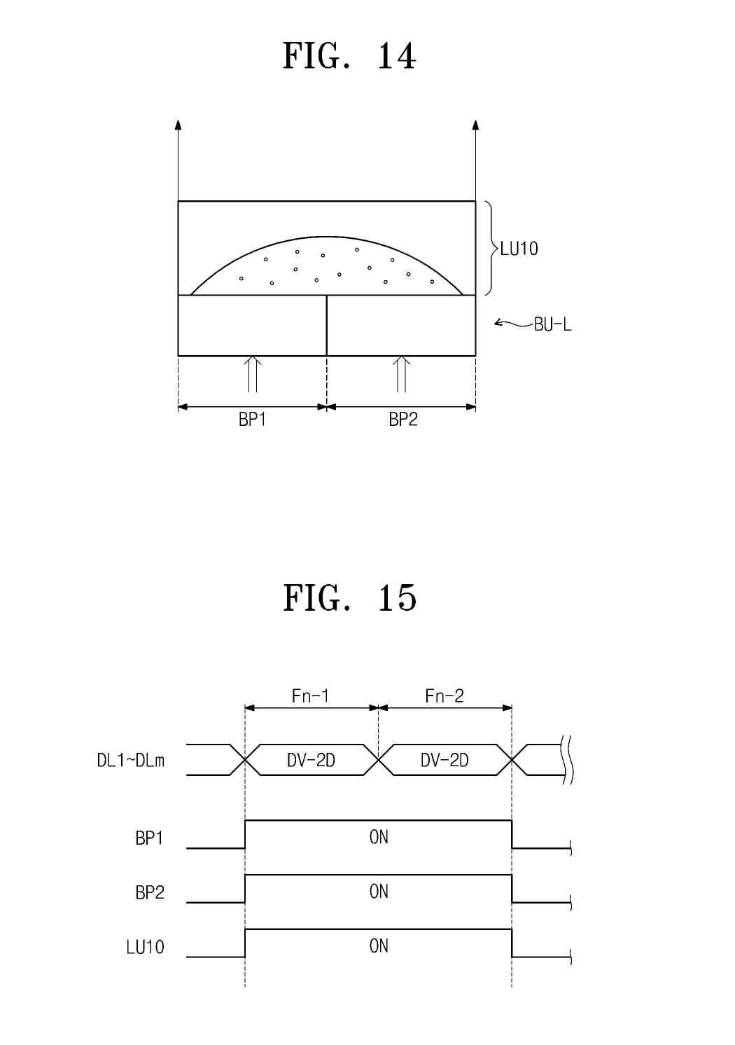

FIG. 14 is a view showing an exemplary embodiment of an optical control member driven in a 2D mode, according to the invention, and FIG. 15 is a timing diagram showing a 2D mode of an exemplary embodiment of a display device according to the invention. FIG. 14 shows the barrier unit BL-U disposed at the left side of FIG. 3B and the lens unit LU10 corresponding to the barrier unit BL-U.

The 2D mode display module displays the 2D image every frame period Fn-1 and Fn-2. 2D data signals DV-2D are applied to the pixels PX11 to PXnm (refer to FIG. 2), respectively, every frame period Fn-1 and Fn-2.

The first and second areas BP1 and BP2 are driven in the activation mode ON during the frame periods Fn-1 and Fn-2 of the 2D mode. The transmission pattern is formed in the barrier unit BU-L in synchronization with the 2D image. The light provided from the backlight module BLU (refer to FIG. 1) is provided to the lens unit LU10 after passing through the transmission pattern of the barrier unit BU-L.

When the display module DM is driven in the 2D mode, the lens unit LU10 is driven in the activation mode ON. The first and second electrodes ELL and ELU are applied with different voltages from each other. When the electric field is formed between the first and second electrodes ELL and ELU, the liquid crystal droplets LPD are aligned in a predetermined direction. When the intensity of the electric field is increased, the liquid crystal droplets LPD may be completely aligned in the predetermined direction to allow the external focal length becomes infinite.

As described above, when the focusing function of the lens unit LU10 disappears, the lens unit LU10 may not change a direction of the light passing therethrough such that a moiré phenomenon, which is caused by the overlap between the period of the lens units LU10 included in the focus control member LR10 and the period of pixel columns of the display panel DP, may be effectively prevented. In such an embodiment, when the 2D image, which is not focused, is provided to the user, a viewing angle becomes widened. As a result, a display quality of the 2D image is improved.

Although exemplary embodiments of the invention have been described herein, it is understood that the invention should not be limited to these exemplary embodiments but various changes and modifications may be made by one ordinary skilled in the art within the spirit and scope of the invention as hereinafter claimed.

What is claimed is:

1. A display device comprising:
a light source which emits light;
a transmissive display module which generates a two-dimensional image or a three-dimensional image based on an operation mode thereof; and
an optical control member disposed between the light source and the transmissive display module and which provides the light emitted from the light source to the transmissive display module,
wherein the optical control member comprises:
a barrier member comprising a plurality of barrier units, wherein each of the barrier units comprises a polymer-dispersed liquid crystal layer to transmit or reflect the light incident thereto based on an arrangement of liquid crystal droplets therein, and the barrier units form a left-eye barrier pattern and a right-eye barrier pattern at different time points from each other in synchronization with the three-dimensional image; and
a focus control member comprising a plurality of lens units coupled to a surface of the barrier member and corresponding to the barrier units, respectively, wherein each of the lens units is defined by a lenticular lens surface, and the lens units provide the three-dimensional image to different external positions from each other in synchronization with the left-eye barrier pattern and the right-eye barrier pattern.

2. The display device of claim 1, wherein each of the barrier units forms a transmission pattern in synchronization with the two-dimensional image.

3. The display device of claim 2, wherein
the three-dimensional image comprises a left-eye image and a right-eye image, which are alternately displayed with each other,
the barrier units form the left-eye barrier pattern in synchronization with the left-eye image, and
the barrier units form the right-eye barrier pattern in synchronization with the right-eye image.

4. The display device of claim 3, wherein
the left-eye barrier pattern comprises a plurality of left-eye sub-barrier patterns formed at the different time points, and
the lens units provide the left-eye image to positions of the different external positions in synchronization with the left-eye sub-barrier patterns.

5. The display device of claim 2, wherein
each of the barrier units further comprises:
a control electrode; and
a common electrode disposed opposite to the control electrode,
the polymer-dispersed liquid crystal layer is disposed between the control electrode and the common electrode, and
the control electrode comprises:
a first electrode; and
a second electrode spaced apart from the first electrode.

6. The display device of claim 5, wherein
each of the barrier units further comprises:
a first base substrate; and
a second base substrate spaced apart from the first base substrate, the first and second electrodes are disposed on the first base substrate, the common electrode is disposed on the second base substrate, and
the polymer-dispersed liquid crystal layer is disposed between the first and second base substrates.

7. The display device of claim 5, wherein the common electrode comprises:
a first common electrode disposed opposite to the first electrode; and
a second common electrode disposed opposite to the second electrode and spaced apart from the first common electrode.

8. The display device of claim 5, wherein
the left-eye barrier pattern is formed when the first electrode has an electric potential different from the second electrode and the common electrode, and the second electrode and the common electrode have electric potentials substantially the same as each other, and
the right-eye barrier pattern is formed when the second electrode has an electric potential different from the first electrode and the common electrode, and the first electrode and the common electrode have electric potentials substantially the same as each other.

9. The display device of claim 5, wherein the transmission pattern is formed when the first electrode, the second electrode and the common electrode have electric potentials substantially the same as each other.

10. The display device of claim 1, wherein
the barrier units and the lens units are arranged in a predetermined direction,
each of the barrier units has a first width in the predetermined direction, and
each of the lens units has a second width less than the first width in the predetermined direction.

11. The display device of claim 10, wherein the lens units comprise:
a first lens unit disposed at a center position in the predetermined direction; and
a second lens unit disposed at an outer position in the predetermined direction,
wherein
the barrier units comprise a first barrier unit corresponding to the first lens unit, and both ends of the first lens unit overlap the first barrier unit.

12. The display device of claim 11, wherein
the barrier units further comprise a second barrier unit corresponding to the second lens unit,
one end of the second lens unit overlaps the second barrier unit,
the other end of the second lens unit does not overlap the second barrier unit, and the one end of the second lens unit is spaced apart further from the first lens unit than the other end of the second lens unit.

13. The display device of claim 1, wherein each of the lens units comprises:
a first electrode disposed on a base substrate;
a body part coupled to the base substrate, wherein a surface of the body part defines the lenticular lens surface, wherein the lenticular lens surface defines a predetermined space with the base substrate;
a polymer-dispersed liquid crystal mixture material disposed in the predetermined space to control an external focal length of a corresponding lens unit of the lens units; and
a second electrode disposed on the body part.

14. The display device of claim 13, wherein the base substrate defines a portion of the barrier member.

15. The display device of claim 13, wherein the polymer-dispersed liquid crystal mixture material comprises:
a polymer matrix; and
the liquid crystal droplets dispersed in the polymer matrix,
wherein each of the liquid crystal droplets comprises liquid crystal molecules.

16. The display device of claim 15, wherein the polymer matrix comprises a nano-polymer.

17. The display device of claim 15, wherein the body part comprises a same material as the polymer matrix.

18. The display device of claim 15, further comprising:
a protective layer coupled to the body part to protect the second electrode.

19. The display device of claim 1, wherein the transmissive display module comprises:
a liquid crystal display panel; and
two polarizers disposed opposite to each other,
wherein the liquid crystal display panel is disposed between the two polarizers.
